(19) United States
(12) Patent Application Publication
(10) Pub. No.: US 2025/0153394 A1
(43) Pub. Date: May 15, 2025

(54) ONLINE RHEOLOGY DETERMINATION IN ADDITIVE MANUFACTURING PROCESSES

(71) Applicant: SIKA TECHNOLOGY AG, Baar (CH)

(72) Inventors: Raphael BOURQUIN, Mönchaltorf (CH); Patrik KUHN, Zürich (CH); Didier LOOTENS, Kriens (CH); Maxime LIARD, Zürich (CH)

(73) Assignee: SIKA TECHNOLOGY AG, Baar (CH)

(21) Appl. No.: 18/839,932

(22) PCT Filed: Apr. 3, 2023
(86) PCT No.: PCT/EP2023/058666

§ 371 Date: Aug. 20, 2024

(30) Foreign Application Priority Data
Apr. 8, 2022 (EP) 22167445.0

(51) Int. Cl. B28C 7/02; B28B 1/00; B28C 5/12; B28C 7/04; B28C 7/16; B33Y 10/00; B33Y 30/00; B33Y 40/10; B33Y 50/02

(52) U.S. Cl. CPC B28C 7/024; B28B 1/001; B28C 5/1261; B28C 7/026; B28C 7/0418; B28C 7/163; B33Y 10/00; B33Y 30/00; B33Y 40/10; B33Y 50/02

(57) ABSTRACT

A method for producing a three-dimensional object from a curable binder composition with an additive manufacturing process, the method including the steps of: producing the curable binder composition in the setting state, preferably by mixing the constituents of the curable binder composition in a mixing unit, conveying the curable binder composition in the setting state via a supply line to a printing head movable in at least one spatial direction, applying the curable binder composition in the setting state by means of the printing head, wherein the curable binder composition is preferably applied layer-by-layer, to form the three-dimensional object, determining a pressure drop over a length section of the supply line with at least two pressure measuring device(s), optionally, determining a flow rate of the curable binder composition in the supply line, optionally determining a temperature of the curable binder composition in the supply line.

### TECHNICAL FIELD

The invention relates to a method and a system for producing a three-dimensional object from a curable binder composition, especially a curable mineral binder composition, with an additive manufacturing process.

### BACKGROUND ART

In construction industry, curable binder compositions, such as e.g. mineral binder compositions, are widely used for various applications. Examples of such compositions are mortar, concrete, grout, or screed compositions.

Attempts have been made for some time to produce geometrically demanding construction elements using additive manufacturing processes. The term “additive manufacturing process” or “additive production” refers to processes in which a spatial object or a molded body is produced by the targeted spatial deposition, application and/or solidification of material.

The deposition, application and/or consolidation of the material, e.g. the curable binder composition, is carried out in particular on the basis of a data model of the object to be generated and in particular layer-by-layer. Thus, in the additive manufacturing process, each object is typically produced from one or more layers.

Usually, a formless material (e.g. liquids, powders, granulates, etc.) and/or a form-neutral material (e.g. tapes, wires) is used to manufacture an object, which is subjected in particular to chemical and/or physical processes (e.g. melting, polymerizing, sintering, curing). Additive manufacturing processes are also referred to as “generative manufacturing processes” or “3D printing”, among others.

Additive manufacturing in the construction sector is quickly developing and projects involving this technology are becoming more and more ambitious. However, additive manufacturing is based on a rather difficult interplay between the material to be applied, e.g. a curable binder composition, and the application device, e.g. a 3D printing device. However, the physical and chemical properties of curable binder compositions, such as e.g. concrete mixtures, make the generative production of concrete elements very difficult. Inter alia this is due to the rheological properties of curable binder compositions, which usually are non-Newtonian fluids, and the kinetics of the curing processes.

In this regard, WO 2020/260375 A1 (Saint-Gobain Weber) describes a method suitable for 3D printing of elements comprising hydraulic binder and aggregates. Thereby, a dry mortar composition comprising hydraulic binder and aggregates is mixed with water, to form a wet mortar, and the wet mortar is pumped and conveyed towards an outlet. During conveying, at least two physical properties of the wet mortar are measured online, whereby said physical properties include viscosity and at least one of flow and density. The physical properties are measured independently by one or more sensors without calculation of a physical property via another measured physical property. The sensor described is a Coriolis type sensor arranged as close as possible to the pump and capable of measuring simultaneously density, flow, viscosity, and temperature of the wet mortar during conveying. The system may further comprise a feedback control system that continuously controls the mixing ratio of the mortar composition to obtain stable values for some of the physical properties of the wet mortar.

However, measuring the physical properties of wet mortar compositions with a Coriolis type sensor is highly difficult and turned out to give rather unreliable results. Thus, controlling the mixing ratio of a mortar composition based on such measurements is not fully satisfying for 3D printing applications.

Thus, there is still a need for new and improved solutions that overcome the aforementioned disadvantages as far as possible.

### DISCLOSURE OF THE INVENTION

It is an object of the present invention to provide improved solutions for preparing three-dimensional objects from curable binder compositions, especially curable mineral binder compositions, with an additive manufacturing process. In particular, a constant quality of the curable binder composition is to be achieved during the whole process. Furthermore, blocking of the curable binder composition in the print head as well as uncontrolled running of the material after discharge should be avoided as good as possible.

Surprisingly, it was found that these objects can be achieved with the method according to independent claim 1.

Specifically, according to the invention, a method for producing a three-dimensional object from a curable binder composition with an additive manufacturing process, comprising the steps of:
Producing the curable binder composition in the setting state, preferably by mixing the constituents of the curable binder composition in a mixing unit,
Conveying the curable binder composition in the setting state via a supply line to a printing head movable in at least one spatial direction,
Applying the curable binder composition in the setting state by means of the printing head, wherein the curable binder composition is preferably applied layer-by-layer, to form the three-dimensional object,
Determining a pressure drop over a length section of the supply line with one or more pressure measuring device(s),
Optionally, determining a flow rate of the curable binder composition in the supply line,
Optionally determining a temperature of the curable binder composition in the supply line.

As it turned out, measuring the pressure drop and optionally the flow rate and/or the temperature in the supply line allows for a very meaningful estimation of the rheological properties of the curable binder composition in setting state when conveying it towards the printing head in real time. Especially, the viscosity of the curable binder composition in setting state can be determined from these measured parameters and supply line dimensions, e.g. by using known fluid models.

Knowing the measured parameters and/or rheological properties in real time is highly beneficial because deviations from target values can be identified and suitable actions can be initiated, e.g. alerting an operator, adjusting operating conditions in order to keep the measured parameters within the range of target values and/or stopping the manufacturing process. Deviations may e.g. be caused by fluctuations of raw material quality and/or by operator errors.

Overall, the inventive method is useful to produce high quality printed three-dimensional objects. Especially, it drastically increases the safety of the additive manufacturing process because any issue with regard to rheology of the curable binder composition in the supply line can be detected instantaneously and directly be solved. In case of potential danger, it is for example possible to stop the application before the printed object collapses due to a too thin curable binder composition or before the supply line is blocked because of a too viscous curable binder composition.

Compared to known solutions using e.g. Coriolis sensors, the inventive approach has turned out to be more precise and reliable.

Further aspects are described below and are subject of the further independent claims. Particularly preferred embodiments are outlined throughout the description and the dependent claims.

### WAYS OF CARRYING OUT THE INVENTION

A first aspect of the present invention is directed to a method for producing a three-dimensional object from a curable binder composition, especially curable mineral binder composition, with an additive manufacturing process, comprising the steps of:
Producing the curable binder composition in the setting state, preferably by mixing the constituents of the curable binder composition in a mixing unit,
Conveying the curable binder composition in the setting state via a supply line to a printing head movable in at least one spatial direction, especially with a movement device,
Applying the curable binder composition in the setting state by means of the printing head, wherein the curable binder composition is preferably applied layer-by-layer, to form the three-dimensional object,
Determining a pressure drop over a length section of the supply line with at least two pressure measuring device(s),
Optionally, determining a flow rate of the curable binder composition in the supply line, especially with a flow rate measuring unit,
Optionally determining a temperature of the curable binder composition in the supply line, especially with a temperature measuring unit.

A “curable binder composition” stands for a material which is typically flowable or liquefiable and which, after mixing, for example by the addition of mixing water, or by the mixing of components or by heating, can cure by a chemical reaction to form a solid. For example, these are reaction resins, mineral binders, mineral binder compositions or mixtures thereof.

In particular, reactive resins are liquid or liquefiable synthetic resins that cure by polymerization or polyaddition to form duromers. For example, unsaturated polyester resins, vinyl ester resins, acrylic resins, epoxy resins, polyurethane resins and/or silicone resins can be used.

Especially preferred, the curable binder composition is a curable mineral binder composition.

The term “mineral binder” refers in particular to a binder which reacts in the presence of water in a hydration reaction to form solid hydrates or hydrate phases. This can be, for example, a hydraulic binder (e.g. cement or hydraulic lime), a latent hydraulic binder (e.g. slag), a pozzolanic binder (e.g. fly ash) or a non-hydraulic binder (e.g. gypsum or white lime).

A “mineral binder composition” is accordingly a composition containing at least one mineral binder. In particular, it contains the binder, aggregates and optionally one or more additives. Aggregates may be, for example, aggregates, gravel, sand (in natural and/or processed (e.g. crushed) form) and/or filler. The mineral binder composition is in particular a fluid binder composition mixed with mixing water.

In particular, the mineral binder or the binder composition contains a hydraulic binder, preferably cement. Particularly preferred is a cement with a cement clinker content of 35% by weight, in particular the cement is of type CEM I, II, III, IV or V, preferably cement of type CEM I (according to standard EN 197-1). A proportion of the hydraulic binder in the total mineral binder is advantageously at least 5% by weight, in particular at least 20% by weight, preferably at least 35% by weight, in particular at least 65% by weight. According to a further advantageous embodiment, at least 95% by weight of the mineral binder consists of hydraulic binder, in particular cement clinker.

However, it can also be advantageous if the binder composition comprises other binders in addition to or instead of a hydraulic binder. These are in particular latent hydraulic binders and/or pozzolanic binders. Suitable latent hydraulic and/or pozzolanic binders are, for example, slag, granulated blast furnace slag, fly ash and/or silica fume. Likewise, the binder composition may include inert materials such as limestone powder, quartz powder and/or pigments. In an advantageous embodiment, the mineral binder contains 5-95% by weight, in particular 5-65% by weight, more specifically 15-35% by weight, of latent hydraulic and/or pozzolanic binders.

The expression “the curable binder composition in the setting state” in particular means that the curable binder composition is in a condition in which the setting of the binder in the curable binder composition has started but is not yet complete.

In case of a mineral binder compositions, the compositions are in the setting state after mixing the mineral binder and optionally further components, such as e.g. aggregates, with the mixing water.

The three-dimensional object produced by the process according to the invention can have almost any desired shape and can, for example, be a finished part for a structure, e.g. for a building, a masonry structure and/or a bridge.

The additive manufacturing process according to the present invention is in particular a generative free space process. This means that the three-dimensional object is formed layer by layer, namely by applying curable material only at those points where the three-dimensional object is to be formed. In the case of overhangs and/or cavities, a support structure can optionally be provided. In contrast, in powder bedding or liquid processes, for example, the entire space is typically filled and the material is then selectively solidified at the desired locations.

Free-space processes have proved to be particularly advantageous in connection with the production of three-dimensional object from curable binder composition.

In particular, the curable binder composition is produced in the setting state by mixing of the components of the curable binder composition in a mixing unit. Most preferably, the curable binder composition is continuously produced in the setting state, especially during the application of the curable binder composition.

For conveying the curable binder composition in the setting state via a supply line to a printing head, the additive manufacturing device comprises in particular a conveying device, in particular a pump, with which the curable binder composition can be conveyed to the printing head via the supply line.

The supply line can have a length of for example 50 cm to 100 m, especially 2 m to 50 m.

A length section over which the pressure drop is determined in the supply line can e.g. be from 0.5-10 m, especially 1-5 m.

In particular, determining the pressure drop, and optionally the flow rate and/or the temperature, takes place simultaneously with the production of the curable binder composition and the conveying of the curable binder composition in the setting state via the supply line. This allows for a real time measurement and optionally adjustment of the proportion of the constituents of the curable binder composition in the mixing unit based on the determined parameters.

For applying the curable binder composition in the setting state, the printing head is in particular controlled on the basis of a structural data model of the three dimensional object. The structural data model may be stored in a memory module of a control unit of the additive manufacturing device.

In a further preferred embodiment, a proportion of the constituents of the curable binder composition in the mixing unit are adjusted based on the pressure drop, in particular based on the pressure drop and at least one of the flow rate and the temperature. This can be done manually and/or automatically and allows to compensate for deviations in rheological properties of the curable binder composition in the setting state.

Especially, the viscosity of the curable binder in the supply line is determined based on the pressure drop, the flow rate and optionally the temperature. Thereby, parameters such as the length of the length section, the radius and/or the diameter of the supply line at the length section are considered too.

Additionally, the proportions of the constituents of the curable binder composition in the mixing unit are preferably adjusted based on the calculated viscosity. In this manner, the adjustment of the proportions of the constituents of the curable binder composition is based on a highly meaningful parameter, i.e. the viscosity. This allows for a more direct and intuitive compensation of deviations in rheological properties of the curable binder composition in the setting state.

However, the proportions of the constituents of the curable binder composition in the mixing unit can be adjusted manually, if desired.

Calculating viscosities from pressure drops and flow rates in a line is in principle known to the skilled person.

For calculating the viscosity in the supply line, a power-law fluid model or an Ostwald-de Waele relationship, respectively, can for example be used.

Thereby, the viscosity is in general determined as follows: η=K·\dot{γ}ⁿ⁻¹ with η=viscosity, K=flow consistency (Pa·s), n=power law constant and √\dot{γ}=shear rate. The values of K and n can be obtained by calibration.

Especially the viscosity (η) can be calculated from the flow rate (Q), the pressure drop (Δp), the length of the pressurd drop (L) and the radius (R) of the supply line as follows:

$$η = \frac{Δ pR}{2 L \dot{γ}}$$

whereby

$$\dot{γ} = - \frac{1}{π {R}^{3}} ( 3 + \frac{d ln Q}{d ln Δ p} ) .$$

### Thereby,

$$\frac{d ln Q}{d ln Δ p}$$

represents the slope of the function of ln Q versus ln Δp. For a non-Newtonian fluid such as curable binder compositions

$$\frac{d ln Q}{d ln Δ p}$$

is different from 1.

However, other models might be used as well to calculate the viscosity.

Especially preferred, the proportion of the constituents of the curable binder composition in the mixing unit are automatically adjusted with a control unit such that:
the pressure drop, and optionally at least one of the flow rate and the temperature, is within a pre-determined range of target values for pressure drop, and optionally within a pre-determined range of target values of at least one of the flow rate and the temperature; and/or
such that the calculated viscosity is within a pre-determined range of target values for viscosity.

A pre-determined range of target values preferably are stored in a memory module of the control unit. The pre-determined range of target values in particular comprises at least a lower limit and an upper limit. These limits may be identical. In this case the pre-determined range of target values equals a single pre-determined value.

Automatically adjusting the constituents of the curable binder composition in the mixing unit preferably is affected with a control loop having a control element, especially one or more constituent supply unit(s), that is controlled based on the pressure drop, and optionally at least one of the flow rate and the temperature, as process variables. The control loop may for example be implemented in the form of a proportional-integral controller (PI controller) or in the form of a proportional-integral-derivative controller (PID controller).

In this way, the rheological properties of the curable binder composition in setting state can be held constant within desired ranges in a highly reliable manner.

In case of a curable mineral binder composition, for example, the curable binder composition comprises a first component comprising a mineral binder and an aggregate, a second component comprising water, and optionally at least a third component comprising one or more additive(s). The additive in particular, is an additive for controlling the chemical and/or physical properties of the curable binder composition. Preferably, the additive is selected from an accelerator, a retarder, a rheological aid and/or a superplasticizer. In particular, the additive is an additive for mineral binder compositions.

Thereby, the proportions of the first and second components, and optionally the proportions of the third and/or any further component, mixed in mixing unit are adjusted based on the measured pressure drop, in particular based on the pressure drop and at least one of the flow rate and the temperature, and/or based on the calculated viscosity.

Thereby, the proportion of the first component in particular can be controlled with a first constituent supply unit, e.g. with a powder dosing device. A powder dosing device may comprise a controllable valve and a balance for weighing the weight of powder introduced into the mixing unit.

Alternatively or in addition, the proportion of the second component, i.e. water, in the mixing unit in particular can be adjusted with another constituent supply unit, e.g. a controllable liquid dosing device. For example the liquid dosing device comprises a valve with a flow meter to measure the amount of water introduced into the mixing unit.

Likewise, the proportion(s) of the third and/or any further component(s) in the mixing unit in particular can be adjusted with additional constituent supply unit(s), e.g. controllable liquid dosing device(s), in particular comprising a valve with a flow meter to measure the amount of additive introduced into the mixing unit.

However, it is possible to feed one or more of the components at a constant rate into the mixing unit, whereas the proportion(s) of the other component(s) is/are controlled as described above.

Also, it is possible to premix the third and/or any further component comprising one or more additive(s) with the first and/or the second component before adding them to the mixing unit. This can be helpful to obtain a more precise dosing of the additives, which usually are added with rather low proportions. Also, when premixing, the proportion(s) of the third component and/or any further component can be adjusted based on the measured pressure drop, in particular based on the pressure drop and at least one of the flow rate and the temperature, and/or based on the calculated viscosity. Alternatively, when no adjustment is desired, the proportion(s) of the third component and/or any further component can be kept constant, e.g. by adding them with the desired proportion to the first and/or the second component beforehand.

According to a further preferred embodiment, one or more additive(s) for controlling the chemical and/or physical properties of the setting curable binder composition is/are added to the curable binder composition in the setting state in the printing head and/or in the supply line.

These one or more additive(s) can be the same as the one or more additive(s) comprised in the optional third and/or any further component described above, or they are different.

Thus, in this case, the additive is added to the curable binder composition in setting state downstream the mixing unit. This allows for example for adjusting the properties of the curable binder composition right before application, e.g. in the printing head. Thereby, for example, the consistency and/or rheology of the curable binder composition can be adjusted for proper extrusion and/or layer buildup.

The additive preferably is a substance capable of controlling and/or modifying the flow properties and/or the setting behavior of the curable binder composition. Preferably, the additive is selected from an accelerator, a retarder, a rheological aid and/or a superplasticizer. In particular, the additive is an additive for mineral binder composition.

The additive in particular is added via an additive supply device, optionally with an additive inlet nozzle. The additive supply device and/or the additive inlet nozzle preferably are controllable, in particular with the control unit.

In particular, the additive supply device is arranged downstream the end of the section of the supply line in which the pressure drop is measured.

Especially preferred, the method comprises the steps of:
Before application by means of the printing head, mixing the curable binder composition in the setting state with at least one dynamic mixer comprising a drive and a stirring element coupled to the drive,
Determining the torque required to rotate the stirring element of the dynamic mixer.

It should be noted that these two steps can be performed as further steps of the above described method. However, it is also possible to implement a method in which the above described determination of the pressure drop over a length section of the supply line with one or more pressure measuring device(s) is omitted and instead of it, these two steps are performed.

In the latter case, the method for producing a three-dimensional object from a curable binder composition, especially curable mineral binder composition, with an additive manufacturing process can be implemented based on the following steps of:
Producing the curable binder composition in the setting state, preferably by mixing the constituents of the curable binder composition in a mixing unit,
Conveying the curable binder composition in the setting state via a supply line to a printing head movable in at least one spatial direction,
Before application by means of the printing head, mixing the curable binder composition in the setting state with at least one dynamic mixer comprising a drive and a stirring element coupled to the drive,
Determining the torque required to rotate the stirring element of the dynamic mixer.
Optionally, determining a flow rate of the curable binder composition in the supply line,
Optionally determining a temperature of the curable binder composition in the supply line.

Regardless of the type of implementation, in the at least one dynamic mixer, the stirring element is configured for mechanically mixing the curable binder composition, and optionally one or more additive(s). The stirring element comprises for example one or more stirring shaft(s) and/or stirring blade(s).

In particular, the at least one dynamic mixer is arranged between a print head outlet, especially the outlet nozzle, and the end of the section of the supply line in which the pressure drop is measured. Especially, the at least one dynamic mixer is arranged between the printing head outlet, especially an outlet nozzle, and the additive supply device, if the latter is present. Particularly preferred, the at least one dynamic mixer is arranged in the printing head.

The torque can be measured with a separate torque-measuring device, with a torque-measuring device integrated in the dynamic mixer and/or via the power consumption of the drive of the dynamic mixer.

Determining the torque turned out to be highly beneficial for improving the quality of the additive manufacturing process as well as the three-dimensional object.

In particular, the torque can be used as measure of the viscosity of the curable binder composition. If the dynamic mixer is installed in the printing head or close to it in the supply line, the viscosity of the curable binder composition right before application with the printing head can be controlled in real time. Deviations from target values for the torque and/or viscosity can be identified and suitable actions can be initiated, e.g. alerting an operator, adjusting operating conditions in order to keep the measured torque within a range of target values and/or stopping the manufacturing process.

In addition, when an additive for controlling the chemical and/or physical properties of the setting curable binder composition is added to the setting curable binder composition after measuring the pressure drop or any other of the parameters, the rheological properties may change significantly without being detectable e.g. based on the measured pressure drop. However, if the at least one dynamic mixer is arranged downstream the region of additive addition, the properties of the curable binder composition intermixed with the additive can be determined directly.

If combined with the measurement of pressure drop, and optionally at least one of the flow rate and the temperature, the quality of manufacturing process and the printed three-dimensional object can be significantly improved with the torque measurement since the curable binder composition can be controlled essentially over the whole conveying and application step.

In particular, the proportion of the constituents of the curable binder composition in the mixing unit are adjusted based on the measured torque and/or the proportion of the additive provided via the additive supply unit are adjusted based on the measured torque. This can be done manually and/or automatically.

Especially preferred, the proportion of the constituents of the curable binder composition in the mixing unit and/or the proportion of the additive are automatically adjusted with a control unit such that the measured torque is within a pre-determined range of target values for torque.

A pre-determined range of target values preferably is stored in the memory module of the control unit. The pre-determined range of target torque values in particular comprises at least a lower limit and an upper limit. These limits may be identical. In this case the pre-determined range of target values equal a single pre-determined torque value.

Automatically adjusting the constituents of the curable binder composition in the mixing unit and/or the proportion of the additive preferably is affected with a further control loop with a control element, especially one or more constituent supply unit(s) and/or an additive supply device, that is controlled based on the torque measurement as process variable. The control loop may for example be implemented in the form of a proportional-integral controller (PI controller) or in the form of a proportional-integral-derivative controller (PID controller). The further control loop may a separate control loop, which is independent of the above mentioned control loop or it may be a combined control loop.

In this way, the rheological properties of the curable binder composition in setting state can be help constant within desired ranges automatically.

A further aspect of the present invention is directed to a system for producing a three-dimensional object from a curable binder composition with an additive manufacturing process having means adapted to execute the steps of the method as described above.

Especially, a system for producing a three-dimensional object from a curable binder composition with an additive manufacturing process, especially for performing the method as described above, comprises:
A mixing unit for mixing the constituents of the curable binder composition to provide a curable binder composition in the setting state,
a printing head movable in at least one spatial direction with a movement device for forming the three-dimensional object, preferably comprising a controllable outlet,
a supply line for supplying the curable binder composition in the setting state to the printing head,
at least two pressure measuring units arranged upstream of the printing head configured to determine pressure drop over a length section of the supply line,
optionally, a flow rate measuring unit arranged upstream of the printing head,
optionally a temperature measuring unit arranged upstream of the printing head.

Features described above in connection with the inventive method are preferably implemented likewise in the inventive system.

Especially, the system comprises one or more constituent supply unit(s), especially one or more powder dosing device(s) and/or one or more liquid dosing device(s). A powder dosing device may comprise a controllable valve and a balance for weighing the weight of powder introduced into the mixing unit. For example, the liquid dosing device comprises a valve with a flow meter to measure the amount of liquid, e.g. water, introduced into the mixing unit. The one or more constituent supply unit(s) preferably are controllable, in particular with the below described control unit.

In a further preferred embodiment, the system comprises an additive supply device, optionally with an additive inlet nozzle. The additive supply device and/or the additive inlet nozzle preferably are controllable, in particular with the below described control unit.

Especially, the additive supply device is arranged in the printing head or in a supply line upstream the printing head, which additive supply unit is configured to add an additive to the curable binder composition in the setting state.

Further preferred, the system comprises:
at least one dynamic mixer comprising a drive and a stirring element coupled to the drive for mixing the curable binder composition in the setting state before application with the printing head,
a torque measuring unit configured to determine the torque required to rotate the stirring element of the dynamic mixer.

It should be noted that these two features can be embodied as further features of the above described system. However, it is also possible to implement a system in which the above described system does not comprise at least two pressure measuring units arranged upstream of the printing head configured to determine pressure drop over a length section of the supply line and instead of it, these two featured are foreseen.

Regardless of the type of embodiment, the stirring element comprises for example one or more stirring shaft(s) and/or stirring blade(s).

In particular, the system comprises a control unit for controlling the additive manufacturing process of the three-dimensional object. The control unit preferably comprises a processor module, a memory module for storing data and one or more interface module(s) especially for sending and/or receiving data to/from individual components of the system, especially to/from the measuring unit(s), the constituent supply unit(s), the additive supply device, the dynamic mixer, the printing head and/or the movement device for moving the printing head.

Preferably, the memory module comprises a memory area in which a three-dimensional model of the three-dimensional object to be manufactured and/or target values are stored.

Especially, the control unit is configured to determine the viscosity of the curable binder composition in the supply line based on the measured pressure drop, flow rate, and optionally temperature. The determination of the viscosity in particular is implemented as described above in connection with the inventive method.

In particular, the control unit is configured to:
adjust the proportion of the constituents of the curable binder composition in the mixing unit by controlling one or more constituent supply unit(s),
optionally, adjust the proportion of the additive in the setting curable binder composition by controlling the additive supply device.

Further preferred, the control unit is configured to automatically control the proportion of the constituents of the curable binder composition such that:
the pressure drop, and optionally at least one of the flow rate and the temperature, is within a pre-determined range of target values for pressure drop, and optionally within a pre-determined range of target values of at least one of the flow rate and the temperature, and/or
such that the calculated viscosity is within a pre-determined range of target values for viscosity.

Methods for automatically controlling the proportion of the constituents in the curable binder composition of the additive are described above in connection with the inventive method can be implemented in the control unit accordingly. Corresponding target values preferably are stored in the memory module of the control unit.

Moreover, the control unit preferably is configured to automatically control the proportion of the additive in the curable binder composition such that the measured torque is within a pre-determined range of target values for torque. Methods for automatically controlling the proportion of the additive are described above in connection with the inventive method and can be implemented in the control unit accordingly. Corresponding target values preferably are stored in the memory module of the control unit.

Another aspect of the present invention is directed to a computer program comprising instructions to cause the system as described above to execute the method as described above. The computer program may for example be present on a portable data carrier, stored on a computer system, stored on a server and/or stored in a control unit of an additive manufacturing device.

Further advantageous implementations of the invention are evident from the exemplary embodiments.

### BRIEF DESCRIPTION OF THE DRAWINGS

The drawings used to explain the embodiments show:

FIG. 1 An exemplary system for producing a three-dimensional object from a curable binder composition with an additive manufacturing process.

### EXEMPLARY EMBODIMENTS

### Method and Device for Additive Manufacturing

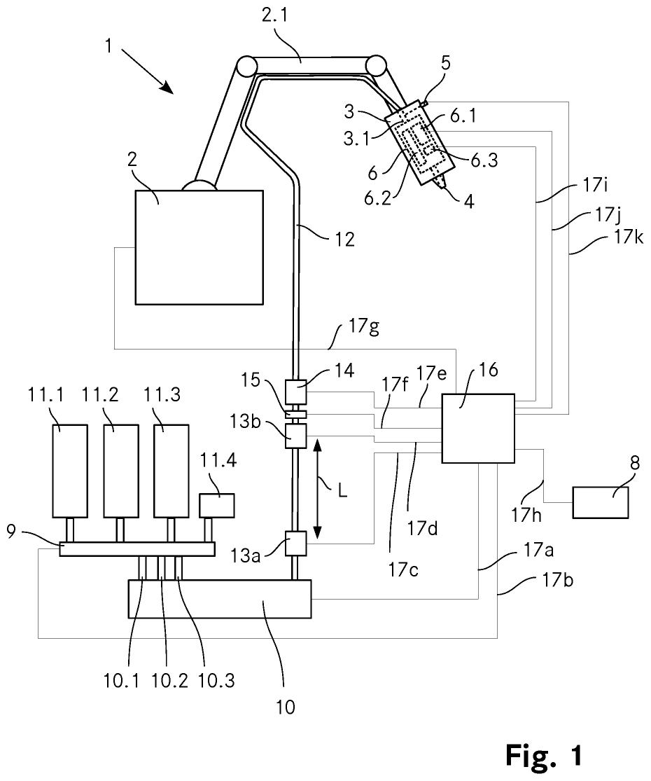

FIG. 1 schematically shows an exemplary system 1 for producing a three-dimensional object from a curable binder composition with an additive manufacturing process.

The system 1 comprises a movement device 2 with a movable arm 2.1. A printing head 3 is attached to the free end of the arm 2.1, which can be moved by the arm 2.1 in all three spatial dimensions. Thus, the printing head 3 can be moved to any position in the working area of the movement device 2.

Inside, the printing head 3 has a tubular passage 3.1 passing through from the end face facing the arm 2.1 (at the top in FIG. 1) to the opposite and free end face. The tubular passage 3.1 is configured for conveying a curable binder composition. At the free end, the passage 3.1 opens into an outlet nozzle 4.

The printing head 3 comprises an additive supply device 5 consisting of a pump and an inlet nozzle, which opens into passage 3.1. Through the inlet nozzle of the additive supply device 5, an additive, for example a rheological aid or an accelerator, can be added to the curable binder composition flowing through the passage 3.1 as required. Optionally, the printing head 3 may comprise supply devices for adding one or more further additives.

Furthermore, inside the printing head 3, downstream with respect to the additive supply device 5, a dynamic mixer 6 is arranged in the passage 3.1, which additionally mixes the curable binder composition and the additive. The dynamic mixer comprises a drive unit 6.1, which is configured for powering a stirring shaft 6.2 for mechanically mixing the curable binder composition and the additive. Additionally, the dynamic mixer 6 comprises a torque measurement device 6.3 that is configured for measuring a torque acting on the stirring shaft 6.2 during operation.

The system 1 for applying a curable binder composition also has a feed device 9 which corresponds on the input side with three containers 11.1, 11.2, 11.3 and an additive reservoir 11.4. Each of the three containers 11.1, 11.2, 11.3 contains one component of the curable binder material. The first component, which is present in the first container 11.1, is for example a dry mineral binder composition, e.g. a cement or a dry mortar. The second component, which is present in the second container 11.2, consists of water, for example. The third component present in the third reservoir 11.3 is, for example, a superplasticizer in the form of a polycarboxylate ether. In the additive reservoir 11.4, there is present, for example, a rheological aid and/or accelerator, e.g. modified cellulose and/or a microbial polysaccharide.

On the output side, the feed device 9 has three separate outlets, each of which is connected to one of three inlets 10.1, 10.2, 10.3 of a mixing unit 10. The feed device 9 also has individually controllable constituents supply units, e.g. powder dosing device(s) and/or one or more liquid dosing device (not shown in FIG. 1), so that the individual components in the individual containers 11.1, 11.2, 11.3 can be metered individually into the mixing unit 10. The powder dosing device for example comprises a controllable valve and a balance for weighing the weight of powder introduced into the mixing unit 10. A liquid dosing device for example comprises a valve with a flow meter to measure the amount of water or plasticizer introduced into the mixing unit

A further outlet of the feed device 9 is connected to the additive supply device 5 (not shown in FIG. 1), so that additive can be fed from the additive reservoir 11.4 to the additive supply device 5 via a further metering device of the feed device 9.

The mixing unit 10 is designed as a dynamic mixer and comprises, in addition thereto, an integrated conveying device in the form of a screw conveyor. In the mixing device, the individually metered components are mixed together and conveyed into the flexible supply line 12 attached to the outlet side of the mixing unit 10. In operation, the mixing and conveying of the curable binder composition can take place continuously.

The curable binder composition can be conveyed into the printing head 3 via the flexible supply line 12, which opens into the tubular passage 3.1, and continuously applied through the outlet nozzle 4.

Also, part of the system 1 are two pressure measuring devices 13a, 13b integrated in the supply line at a distance L. The pressure measuring devices 13a, 13b are configured for measuring the pressure of the curable binder composition in the supply line 12 at two separate positions or the pressure drop of the length L, respectively.

Furthermore, there are a flow meter 14 and a temperature sensor 15 integrated in the supply line 12 downstream the pressure measuring devices 13a, 13b. The flow meter includes, for example, an ultrasonic transducer which is designed to determine the flow properties of the curable binder composition in setting state.

A central control unit 16 of the system 1 includes a processor module, a memory module, and a plurality of interfaces for receiving data and a plurality of interfaces for controlling individual components of the system 1.

In this regard, the mixing unit 10 is connected to the control unit 16 via a first control line 17a, while the feeding device 9 is connected to the control unit 16 via a second control line 17b. As a result, the individual components in the containers 11.1, 11.2, 11.3 can be metered into the mixing unit 10 via the control unit 16 in accordance with predetermined recipes stored in the control unit 16 and conveyed into the supply line 12 at adjustable conveying rates.

The additive supply device 5 is connected to the control unit 16 via a separate control line 17k and can be controlled or monitored by the control unit 16.

The movement device 2 is also connected to the control unit 16 via a further control line 17g. This means that the movement of the printing head 3 can be controlled via the control unit 16.

Similarly, the pressure measuring devices 13a, 13b are connected to the control unit 16 by control lines 17c, 17d, so that data recorded in the pressure measuring devices 13a, 13b can be transmitted to the control unit 16. Likewise, the flow meter 14 and the temperature sensor 15 are connected to the control unit via control lines 17e, 17f.

The dynamic mixer 6 in the printing head 3 can be controlled via control line 17j and the torque measurement device 6.3 is connected with the control unit 16 via control line 17i.

Furthermore, the control unit 16 is connected via control line 17h with an interface unit 8 having a user interface that allows for controlling the system 1 and displaying data.

The control unit 16 is thereby configured, for example, in such a way that:
(i) a curable binder composition in setting state is continuously produced in the mixing unit 10 based on a recipe stored in the memory module of the control unit 16;
(ii) while conveying the curable binder composition in setting state through supply line 12 and applying it with the printing head 3 for producing a three-dimensional object based on a data model stored in the memory module of the control unit 16, the pressure drop over the length L is determined with the pressure measuring devices 13a, 13b and the flow rate of the curable binder composition is determined with the flow meter 14;
(iii) the viscosity of the curable binder composition in setting state is calculated according to a power law model as described above;
(iv) With a control loop implemented in the control unit, e.g. a PID controller, the feeding device 9 is controlled such that a proportion of one of the components 11.1, 11.2, 11.3, e.g. water, is adjusted in order to keep constant the viscosity within target range values for viscosity stored in the memory module of the control unit 16;
(v) The torque acting on the stirring shaft is measured simultaneously with the torque measurement device 6.3;
(vi) With another control loop implemented in the control unit, e.g. a PID controller, the additive supply device 5 is controlled such that a proportion of the additive 11.4, e.g. an accelerator, is adjusted in order to keep constant the torque within target range values for the torque stored in the memory module of the control unit 16;
(vii) the movement device 2, and thus the position of the print head 3, is controlled as a function of a model of the object to be produced stored in the memory module of the control unit 16;
(viii) In case of a malfunction, e.g. if the control loops are not able to set the desired target values, an alert is provided to a user via the interface module 8 and/or the system is stopped.

### Printing Tests

The system 1 as described above was tested with mortar compositions based on cement, sand and water as curable mineral binder composition. Thereby, the components were mixed in the mixing unit 10 according to a standard recipe to obtain a curable mineral binder composition in setting state suitable for 3D printing. The so produced mineral binder composition then was pumped though the supply line 12 to the printing head 3 where an accelerating additive was added to the mineral binder composition in the printing head 3. Three-dimensional test objects produced in this manner have corresponded precisely to the predefined data model.

Further tests were performed without considering the torque and providing the additive at a constant rate. In this case, only the pressure drop and the flow rate were measured and used for adjusting the proportions of the constituents of the mineral binder composition. As it turned out, the quality of the three-dimensional test object produced in this manner was comparable to the first set of experiments. However, it was noted that fluctuations in additive concentration (which were intentionally brought about), gave rise to some imperfections in the printed object.

In another set of tests, the control unit was configured such that the torque measured in the printing head was used for adjusting the proportions of the constituents of the mineral composition. In this case, the pressure drop/flow rate was not considered. The quality of the three-dimensional test object produced in this manner was comparable to the first set of experiments. However, it was noted that fluctuations in the mineral binder composition (which were intentionally brought about), were compensated more slowly than in the first set of experiments giving rise to some imperfections in the printed object.

For reasons of comparison, further tests were performed without determining the pressure drop/flow rate in the supply line 12 and without measuring the torque in the mixing unit 6. In these cases, the quality of the test objects produced were clearly inferior with respect to all of the above described experiments.

It will be appreciated by those skilled in the art that the present invention can be implemented in other specific forms without departing from the spirit or essential characteristics thereof. The presently disclosed embodiments and embodiments are therefore considered in all respects to be illustrative and not restricted.

In particular, the dynamic mixer 6 in the printing head and/or a torque measuring device can be omitted. Likewise measuring the pressure drop and/or flow rate in the supply line can be omitted, such that only the torque is measured and used for controlling the process.

Also, it is possible to implement the system without an automatic adjustment of the proportions of the constituents and/or the additive. In this cases, for example, an alert can be provided to a user and/or the system can be stopped.

1. A method for producing a three-dimensional object from a curable binder composition with an additive manufacturing process, the method comprising the steps of:
producing the curable binder composition in the setting state,
conveying the curable binder composition in the setting state via a supply line to a printing head movable in at least one spatial direction,
applying the curable binder composition in the setting state by means of the printing head, wherein the curable binder composition is applied layer-by-layer, to form the three-dimensional object,
determining a pressure drop over a length section of the supply line with at least two pressure measuring device(s),
optionally, determining a flow rate of the curable binder composition in the supply line,
optionally determining a temperature of the curable binder composition in the supply line.

2. The method according to claim 1, whereby the viscosity of the curable binder in the supply line is determined based on the pressure drop, the flow rate and optionally the temperature, and the proportion of the constituents of the curable binder composition in the mixing unit are adjusted based on the calculated viscosity.

3. The method according to claim 2, wherein for calculating the viscosity, a power-law fluid model is used.

4. The method according to claim 1, wherein the proportion of the constituents of the curable binder composition in the mixing unit are automatically adjusted with a control unit such that:
the pressure drop, and optionally at least one of the flow rate and the temperature, is within a pre-determined range of target values for pressure drop, and optionally a pre-determined range of target values of at least one of the flow rate and the temperature; and/or
such that the calculated viscosity is within a pre-determined range of target values for viscosity.

5. The method according to claim 1, wherein the curable binder composition comprises a first component comprising a mineral binder and an aggregate, a second component comprising water, and optionally at least a third component comprising one or more additive(s), and wherein the proportions of the first and second components, and optionally the proportions of the third and/or any further component, mixed in mixing unit are adjusted based on the measured pressure drop.

6. The method according to claim 1, wherein an additive for controlling the chemical and/or physical properties of the setting curable binder composition is added to the setting curable binder composition in the printing head and/or in the supply line.

7. The method according to claim 1, further comprising the steps of:
before application by means of the printing head, mixing the curable binder composition in the setting state with at least one dynamic mixer comprising a drive and a stirring element coupled to the drive,
determining the torque required to rotate the stirring element of the dynamic mixer.

8. The method according to claim 6, wherein the proportion of the additive in the curable binder composition in the setting state is automatically controlled with the control unit or with a further control unit such that the measured torque is within a pre-determined range of target values for torque.

9. A system for producing a three-dimensional object from a curable binder composition with an additive manufacturing process for performing the method according to claim 1, the device comprising:
a mixing unit for mixing the constituents of the curable binder composition to provide a curable binder composition in the setting state,
a printing head movable in at least one spatial direction with a movement device for forming the three-dimensional object,
a supply line for supplying the curable binder composition in the setting state to the printing head,
at least two pressure measuring units arranged upstream of the printing head configured to determine a pressure drop over a length section of the supply line,
optionally, a flow rate measuring unit arranged upstream of the printing head,
optionally a temperature measuring unit arranged upstream of the printing head.

10. The system according to claim 9, further comprising:
at least one dynamic mixer comprising a drive and a stirring element coupled to the drive for mixing the curable binder composition in the setting state before application with the printing head,
an additive supply unit arranged in the printing head or in the supply line upstream the printing head, which additive supply unit is configured to add an additive to the curable binder composition in the setting state,
a torque measuring unit configured to determine the torque required to rotate the stirring element of the dynamic mixer.

11. The system according to claim 9, further comprising at least one control unit configured to:
adjust the proportion of the constituents of the curable binder composition in the mixing unit by controlling one or more constituent supply unit(s),
optionally, adjust the proportion of the additive in the setting curable binder composition by controlling an additive supply device.

12. The system according to claim 9, wherein the control unit or a further control unit is configured to determine the viscosity of the curable binder composition in the supply line based on the measured pressure drop, flow rate, and optionally temperature.

13. The system according to claim 9, wherein the control unit or a further control unit is configured to automatically control the proportion of the constituents of the curable binder composition such that:
the pressure drop, and optionally at least one of the flow rate and the temperature, is within a pre-determined range of target values for pressure drop, and optionally within a pre-determined range of target values of at least one of the flow rate and the temperature; and/or
such that the calculated viscosity is within a pre-determined range of target values for viscosity.

14. The system according to claim 10, wherein the control unit or a further control unit is configured to automatically control the proportion of the additive in the curable binder composition such that the measured torque is within a pre-determined range of target values for torque.

15. A computer program comprising instructions to cause the system of claim 9 to execute the steps of the method.
